(19) United States
(12) Patent Application Publication
(10) Pub. No.: US 2024/0304958 A1
(43) Pub. Date: Sep. 12, 2024

(54) CYLINDRICAL BATTERY

(71) Applicant: Panasonic Energy Co., Ltd., Moriguchi-shi, Osaka (JP)

(72) Inventors: Suguru Matsumura, Osaka (JP); Oose Okutani, Hyogo (JP)

(73) Assignee: Panasonic Energy Co., Ltd., Moriguchi-shi, Osaka (JP)

(21) Appl. No.: 18/573,563

(22) PCT Filed: Jun. 10, 2022
(86) PCT No.: PCT/JP2022/023470

§ 371 Date: Dec. 22, 2023

(30) Foreign Application Priority Data
Jul. 7, 2021 (JP) 2021-112697

(51) Int. Cl. H01M 50/538; H01M 10/0587; H01M 50/536

(52) U.S. Cl. CPC H01M 50/538; H01M 10/0587; H01M 50/536

(57) ABSTRACT

A cylindrical battery comprises: a wound electrode body having a hollow section extending in the axial direction; and collector plates, each collector plate including a protrusion having an apex accommodated in the hollow section, and a groove part provided integrally with the protrusion on the outside in the radial direction of the protrusion so as to define a groove, the collector plates being more toward the outside in the axial direction than the electrode body. In a core body of at least one of a positive and a negative electrode, a core body exposed portion without a mixture layer is joined to a core body Joining portion (an upper surface of a ridge part, and a lower surface of a ridge part of the collector plate. The core body joining portion includes an opposing part that radially opposes an integral structure comprising the protrusion and the groove part.

### TECHNICAL FIELD

The present disclosure relates to a cylindrical battery.

### BACKGROUND ART

One of conventional cylindrical batteries is disclosed in PATENT LITERATURE 1. In this cylindrical battery, the axial directional end, of an electrode assembly, that is on the bottom side of an exterior can is constituted of a negative electrode, and the end on the bottom side is pressed onto a negative electrode current collector plate. As above, a wide region of the belt-shaped negative electrode in the longitudinal direction is electrically connected to the negative electrode current collector plate to reduce an electric resistance on the negative electrode.

### CITATION LIST

### Patent Literature

PATENT LITERATURE 1: Japanese Unexamined Patent Application Publication No. 2014-186912

### SUMMARY

### Technical Problem

In the aforementioned cylindrical battery, the negative electrode is occasionally inward inclined to the inner side in the radial direction when the negative electrode is pressed onto the negative electrode current collector plate. There, accordingly, occasionally arises a case where an opening of a hollow of the electrode assembly is partially closed. There, hence, occasionally arises a case where, in welding the negative electrode current collector plate and the exterior can, insertion ability of a welding rod into the hollow is worsened and welding ability is affected.

Moreover, also when the end, of the electrode assembly, that is on the sealing side is constituted of a positive electrode and the end on the sealing side is electrically connected to an annular positive electrode current collector plate, there occasionally arises a case where the positive electrode is inward inclined to close a through hole of the positive electrode current collector plate partially, and the inward inclined positive electrode occasionally disturbs injection of an electrolyte into the exterior can.

It is therefore an object of the present disclosure to provide a cylindrical battery in which an end of an electrode assembly may be electrically connected to a current collector plate, and also, the end may be restrained from being inward inclined.

### Solution to Problem

In order to solve the aforementioned problem, a cylindrical battery according to the present disclosure comprises: a wound electrode assembly having a positive electrode and a negative electrode wound via a separator and having a hollow extending in an axial direction; and a current collector plate that has a protrusion portion having an apex housed in the hollow and a groove portion integrally provided with the protrusion portion on an outer side of the protrusion portion in a radial direction to define a groove and that is provided outward of the wound electrode assembly in the axial direction, wherein a core exposed portion in which a mixture layer is not provided on a core of at least one of the positive electrode and the negative electrode is joined to a core joining portion of the current collector plate, and the core joining portion includes a facing portion that faces, in the radial direction, an integrated structure constituted of the protrusion portion and the groove portion.

### Advantageous Effects of Invention

According to the cylindrical battery according to the present disclosure, an end of the electrode assembly may be electrically connected to the current collector plate, and the end may be restrained from being inward inclined.

### BRIEF DESCRIPTION OF DRAWINGS

FIG. 1 is an axial sectional view of a cylindrical battery according to an embodiment of the present disclosure.

FIG. 2 is a perspective view for explaining a structure of an electrode assembly.

FIG. 3 is a plan view of a lower current collector plate as viewed from the upside in the axial direction.

FIG. 4 is a schematic sectional view of a part of the lower side of the aforementioned cylindrical battery.

FIG. 5 is a schematic sectional view showing a lower side of a cylindrical battery of a reference example.

FIG. 6 is a schematic sectional view, corresponding to FIG. 5, of the aforementioned cylindrical battery.

FIG. 7 is a graph showing results of tests for examining hole diameters.

FIG. 8 is a plan view, corresponding to FIG. 3, of a current collector plate of a modification on an integrated structure formation side.

### DESCRIPTION OF EMBODIMENTS

Hereafter, an embodiment of a cylindrical battery according to the present disclosure will be described in detail with reference to the drawings. Notably, the cylindrical battery of the present disclosure may be a primary battery or may be a secondary battery. Moreover, it may be a battery using an aqueous electrolyte or may be a battery using a non-aqueous electrolyte. As a cylindrical battery 10 which is an embodiment, there is exemplarily shown a non-aqueous electrolyte secondary battery (lithium ion battery) using a non-aqueous electrolyte, the cylindrical battery of the present disclosure not being limited to this.

When the following includes a plurality of embodiments, modifications, and the like, it is originally supposed to combine feature portions of those properly to construct a new embodiment. For embodiments below, the same components in the drawings are given the same signs, and their duplicate description is omitted. The plurality of drawings include some schematic diagrams, and dimension ratios in length, width, height, and the like of individual components do not necessarily coincide with one another among the diagrams. In the present specification, for convenience of description, a sealing assembly 16 side of the cylindrical battery 10 in the axial direction (height direction) is regarded as being on the “upside”, and a bottom plate portion 68 side of an exterior can 15 in the axial direction is regarded as being on the “downside”. Among the constituents described below, constituents that are not disclosed in the independent claim showing the superordinate concepts are optional constituents, not the essential constituents.

### Configuration of Cylindrical Battery of Embodiment

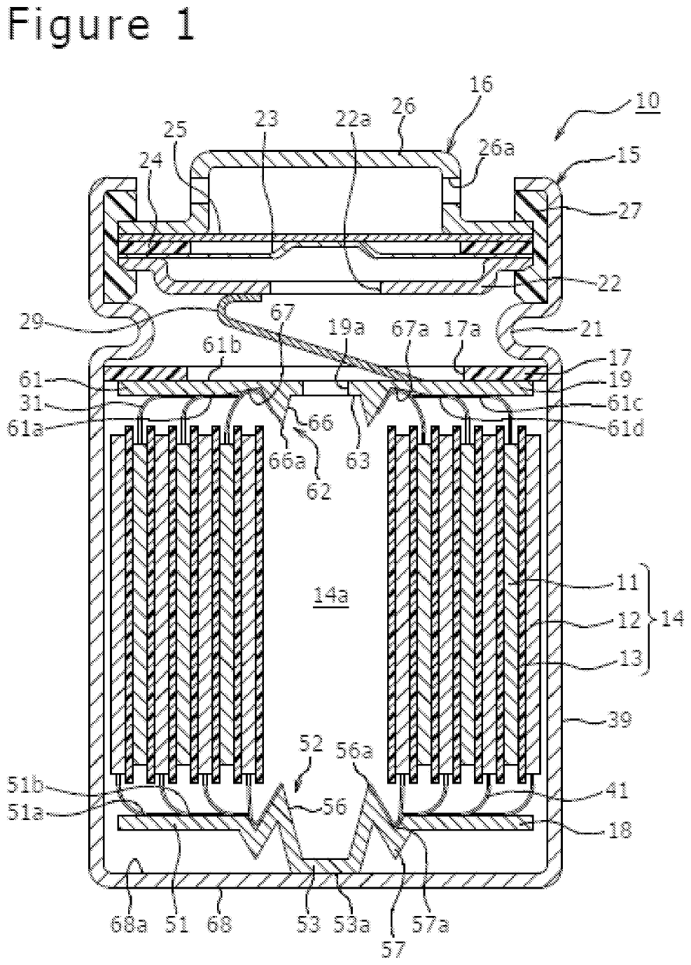

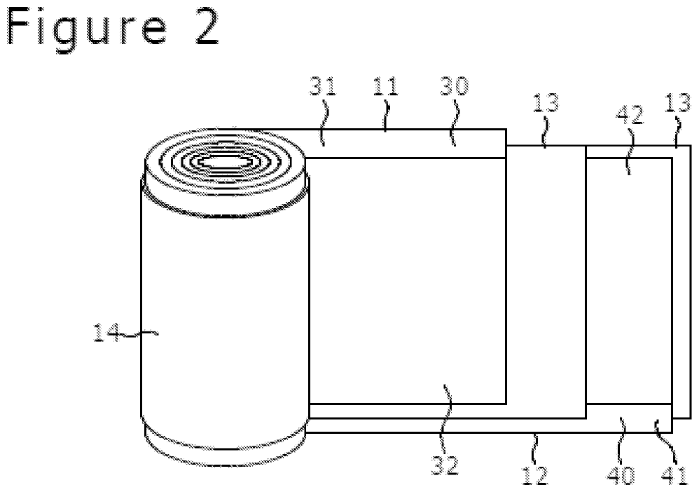

FIG. 1 is an axial sectional view of the cylindrical battery 10 according to an embodiment of the present disclosure, and FIG. 2 is a perspective view for explaining a structure of an electrode assembly 14. As shown in FIG. 1, the cylindrical battery 10 comprises the winding-type electrode assembly 14, a non-aqueous electrolyte (not shown), the bottomed tubular metal-made exterior can 15 that houses the electrode assembly 14 and the non-aqueous electrolyte, and the sealing assembly 16 that closes an opening of the exterior can 15.

As shown in FIG. 1 and FIG. 2, the electrode assembly 14 has a winding structure having a long strip-shaped positive electrode 11 and a long strip-shaped negative electrode 12 wound via two long strip-shaped separators 13. As shown in FIG. 2, the positive electrode 11 protrudes more toward the upside than the negative electrode 12 and the separators 13, and the negative electrode 12 protrudes more toward the downside than the positive electrode 11 and the separators 13. The positive electrode 11 has, at its upper end in the axial direction, a positive electrode core exposed portion 31 in which a positive electrode mixture layer 32 is not provided on a positive electrode core 30 from an end, of the long strip-shaped positive electrode 11, on the side of the start of winding to an end thereof on the side of the finish of winding in the longitudinal direction. Moreover, the negative electrode 12 has, at its lower end in the axial direction, a negative electrode core exposed portion 41 in which a negative electrode mixture layer 42 is not provided on a negative electrode core 40 from an end, of the long strip-shaped negative electrode 12, on the side of the start of winding to an end thereof on the side of the finish of winding in the longitudinal direction. Therefore, the upper end of the electrode assembly 14 in the axial direction is constituted of the positive electrode core exposed portion 31, and the lower end of the electrode assembly 14 in the axial direction is constituted of the negative electrode core exposed portion 41.

The non-aqueous electrolyte includes a non-aqueous solvent and an electrolyte salt dissolved in the non-aqueous solvent. For the non-aqueous solvent, for example, there may be used esters, ethers, nitriles, amides, a mixed solvent of two or more kinds of these, and the like. The non-aqueous solvent may contain a halogen-substituted substance having halogen atom(s) such as fluorine substituted for at least one or some of hydrogen atoms of these solvents. Notably, the non-aqueous electrolyte is not limited to a liquid electrolyte but may be a solid electrolyte using gelatinous polymer or the like. For the electrolyte salt, a lithium salt such as LiPF₆ is used.

The positive electrode 11 has the positive electrode core 30 and the positive electrode mixture layers 32 formed on both sides of the positive electrode core 30. For the positive electrode core 30, there can be used foil of a metal, such as aluminum or aluminum alloy, that is stable in the potential range of the positive electrode 11, a film having the metal disposed on its surface layer, and the like. The positive electrode mixture layers 32 include a positive electrode active material, a conductive agent, and a binder agent. The positive electrode 11 can be produced, for example, by applying positive electrode mixture slurry including the positive electrode active material, the conductive agent, the binder agent, and the like on the positive electrode core 30, and drying the coating film and afterward compressing it to form the positive electrode mixture layers 32 on both sides of the positive electrode core 30. Notably, the positive electrode mixture layer may be formed only on one side of the positive electrode core.

The positive electrode active material is composed of a lithium-containing metal composite oxide as its main component. Examples of metal element(s) contained in the lithium-containing metal composite oxide include Ni, Co, Mn, Al, B, Mg, Ti, V, Cr, Fe, Cu, Zn, Ga, Sr, Zr, Nb, In, Sn, Ta, W, and the like. A preferable example of the lithium-containing metal composite oxide is a composite oxide containing at least one of the group consisting of Ni, Co, Mn, and Al.

For the conductive agent included in the positive electrode mixture layers 32, there can be exemplarily presented carbon materials such as carbon black, acetylene black, Ketjen black, and graphite. For the binder agent included in the positive electrode mixture layers, there can be exemplarily presented fluorine resins such as polytetrafluoroethylene (PTFE) and polyvinylidene fluoride (PVdF), polyacrylonitrile (PAN), polyimide resins, acrylic resins, polyolefin resins, and the like. There may be used, together with these resins, a cellulose derivative such as carboxymethylcellulose (CMC) or its salt, polyethylene oxide (PEO), or the like.

The negative electrode 12 has the negative electrode core 40 and the negative electrode mixture layers 42 formed on both sides of the negative electrode core 40. For the negative electrode core 40, there can be used foil of a metal, such as copper or copper alloy, that is stable in the potential range of the negative electrode 12, a film having the metal disposed on its surface layer, and the like. The negative electrode mixture layers 42 include a negative electrode active material and a binder agent. The negative electrode 12 can be produced, for example, by applying negative electrode mixture slurry including the negative electrode active material, the binder agent, and the like on the negative electrode core 40, and drying the coating film and afterward compressing it to form the negative electrode mixture layers 42 on both sides of the negative electrode core 40. Notably, the negative electrode mixture layer may be formed only on one side of the negative electrode core.

For the negative electrode active material, there is generally used a carbon material that reversibly stores and releases lithium ions. A preferable example of the carbon material is graphite such as natural graphite such as flaky graphite, massive graphite, and earthy graphite, and artificial graphite such as massive artificial graphite and graphitized mesophase carbon microbeads. In the negative electrode mixture layers, there may be included as the negative electrode active material a Si material containing silicon (Si). Moreover, for the negative electrode active material, there may be used a metal, other than Si, that is alloyed with lithium, an alloy containing the metal, a compound containing the metal, and the like.

While for the binder agent included in the negative electrode mixture layers 42, there may be used fluorine resins, PAN, polyimide resins, acrylic resins, polyolefin resins, and the like as with the case of the positive electrode 11, there is preferably used styrene-butadiene rubber (SBR) or its modified substance. The negative electrode mixture layers may include, for example, in addition to SBR or the like, CMC or its salt, polyacrylic acid (PAA) or its salt, polyvinyl alcohol, or the like, for example.

For the separators 13, there is used a porous sheet having ion permeability and insulation ability. Specific examples of the porous sheet include microporous thin films, woven fabric, nonwoven fabric, and the like. For the material of the separators 13, there are preferably employed polyolefin resins such as polyethylene and polypropylene, cellulose, and the like. Each separator 13 may take any of a single layer structure and a laminate structure. On a surface of the separator 13, a heat resistant layer and the like may be formed.

As shown in FIG. 1, the cylindrical battery 10 has a metal-made lower current collector plate (negative electrode current collector plate) 18 composed of nickel, nickel alloy, or the like more on the outer (lower) side than the electrode assembly 14 in the axial direction, the negative electrode core exposed portion 41 of the electrode assembly 14 is joined to the lower current collector plate 18, and the lower current collector plate 18 is joined to an inner surface 68a of the bottom plate portion 68 of the exterior can 15.

The lower current collector plate 18 has radial directional extending portions 51, an integrated structure 52, and a flat plate portion 53. Each radial directional extending portion 51 extends in the substantially radial direction, and the integrated structure 52 is connected to an end, of the radial directional extending portion 51, that is inward in the radial direction. The integrated structure 52 has a protrusion portion 56 having an apex 56a to be housed in a hollow 14a extending in the electrode assembly 14 in the axial direction, and a groove portion 57 integrally provided with the protrusion portion 56 on the outer side of the protrusion portion 56 in the radial direction. The groove portion 57 defines a groove 57a. Moreover, the flat plate portion 53 is connected to an end, of the integrated structure 52, that is inward in the radial direction, and spreads in the substantially radial direction. A bottom surface 53a of the flat plate portion 53 is joined to the inner surface 68a of the bottom plate portion 68 of the exterior can 15.

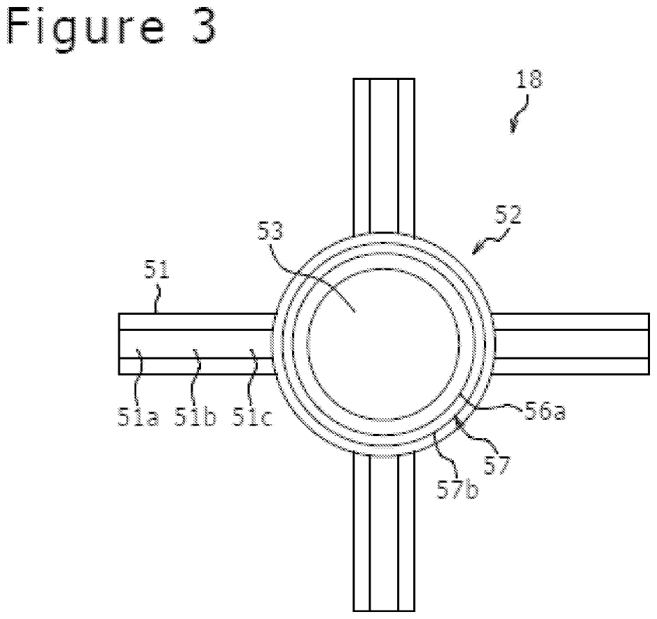

FIG. 3 is a plan view of the lower current collector plate 18 as viewed from the upside in the axial direction. As shown in FIG. 3, the flat plate portion 53 has a disc shape. Moreover, the lower current collector plate 18 has the plurality of radial directional extending portions 51 positioned at intervals in the circumferential direction, and the radial directional extending portions 51 extend from the flat plate portion 53 in the radial direction via the integrated structure 52. Each radial directional extending portion 51 has a ridge 51a extending in the radial direction and protruding upward in the axial direction. An upper surface 51b of each ridge 51a spreads in a direction substantially perpendicular to the axial direction. Moreover, the radial directional extending portion 51 has, on a place that corresponds to the ridge 51a in the axial direction and that is on its lower surface on the lower side in the axial direction, a groove portion (not shown) defining a ridge-like space extending in the radial direction.

Referring to FIG. 1 again, in the state where the upper surface 51b of each ridge 51a of the lower current collector plate 18 is pressed onto the negative electrode core exposed portion 41 constituting the lower end of the electrode assembly 14 in the axial direction, there is irradiated with laser light the bottom side of the groove provided on the lower surface of each radial directional extending portion 51. This laser welding joins the negative electrode core exposed portion 41 of the electrode assembly 14 to the upper surfaces 51b of the ridges 51a of the radial directional extending portions 51. The upper surfaces 51b of the ridges 51a is an example of a core joining portion.

The integrated structure 52 is annular, and in the plan view of FIG. 3, each of the apex 56a of the protrusion portion 56 and the groove bottom 57b of the groove portion 57 has a circle shape around the center of the flat plate portion 53. Therefore, each of the upper surfaces 51b of the ridges 51a constituting the core joining portion includes a facing portion 51c facing the integrated structure 52 in the radial direction. Notably, the flat plate portion may have any shape as long as it has a bottom surface substantially perpendicular to the axial direction, and moreover, each radial directional extending portion does not need to have the ridge or the groove portion. Moreover, the radial directional extending portions may form an annular shape.

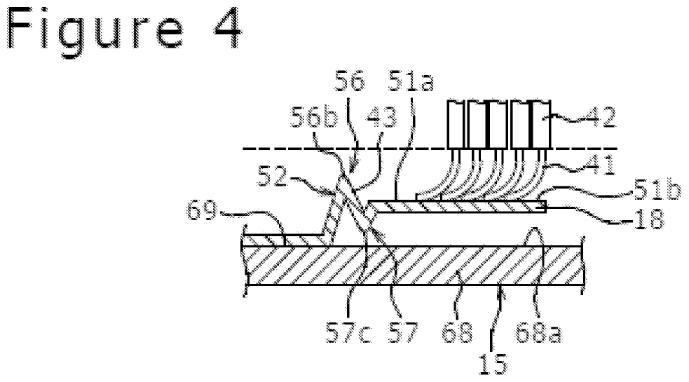

FIG. 4 is a schematic sectional view of a part of the lower side of the cylindrical battery 10 for explaining an axial directional position of a tip 56b of the protrusion portion 56, an axial directional position of a place 57c that is positioned lowermost in the groove portion 57, and the like. As shown in FIG. 4, the lower current collector plate 18 is joined to a plate joining portion 69 that is positioned on an inner surface 68a of the bottom plate portion 68 of the exterior can 15. Moreover, the place 57c on the most bottom plate portion 68 side in the axial direction in the groove portion 57 of the integrated structure 52 of the lower current collector plate 18 is positioned, in the axial direction, between the upper surface (core joining portion) 51b of the ridge 51a of the lower current collector plate 18 and the plate joining portion 69.

Moreover, the tip 56b of the protrusion portion 56 is positioned, in the axial direction, between the upper surface 51b as the core joining portion of the lower current collector plate 18 including the protrusion portion 56 and the negative electrode mixture layers 42 that are provided in the negative electrode core exposed portion 41 joined to the upper surface 51b. Moreover, the integrated structure 52 of the lower current collector plate 18 is positioned outward of the plate joining portion 69 in the radial direction. Moreover, a surface, of protrusion portion 56, that is outward in the radial direction has an inward displacing portion 43 that is displaced more inward in the radial direction as going to the tip 56b of the protrusion portion 56.

Next, a structure of the upper side of the electrode assembly 14 is described. As shown in FIG. 1, the cylindrical battery 10 comprises an upper current collector plate 19 (positive electrode current collector plate) composed of a metal such as aluminum or aluminum alloy more on the outer (upper) side than the electrode assembly 14 in the axial direction, and has an annular insulating plate 17 on its upper side in the axial direction. The upper current collector plate 19 is different from the lower current collector plate 18 in having a substantially flat plate shape and having a through hole 19a at the center in the radial direction, and has the similar structure to that of the lower current collector plate 18 in the other points. In detail, the upper current collector plate 19 includes a plurality of radial directional extending portions 61 that have ridges 61a and grooves 61b and are positioned at intervals in the circumferential direction, an annular integrated structure 62 that are connected to ends, of the radial directional extending portions 61, that are inward in the radial direction, and an annular flat plate portion 63 that is connected to the integrated structure 62.

The integrated structure 62 has a protrusion portion 66 having an apex 66a to be housed in the hollow 14a and protruding downward in the axial direction, and a groove portion 67 integrally provided with the protrusion portion 66 on the outer side of the protrusion portion 66 in the radial direction and defining a groove 67a. The positive electrode core exposed portion 31 of the electrode assembly 14 is joined to lower surfaces 61c of the ridges 61a of the radial directional extending portions 61 by the similar method to that, laser welding, in joining the negative electrode core exposed portion 41. The lower surfaces 61c include facing portions 61d facing the integrated structure 62 in the radial direction. The through hole 19a of the upper current collector plate 19 is positioned inward of the integrated structure 62 in the radial direction.

The cylindrical battery 10 further comprises a sealing assembly 16 and a connection lead 29 composed of a metal such as aluminum or aluminum alloy. A lower end of the connection lead 29 is joined to an upper surface of the upper current collector plate 19 by welding or the like. The connection lead 29 extends to the sealing assembly 16 side through a through hole 17a of the insulating plate 17, and an upper end of the connection lead 29 is connected to a lower surface of a bottom plate 22 of the sealing assembly 16 by welding or the like. A terminal plate 26 constituting a top plate of the sealing assembly 16 is electrically connected to the bottom plate 22, and the terminal plate 26 works as a positive electrode terminal. Moreover, the exterior can 15 to which the negative electrode core exposed portion 41 is connected via the lower current collector plate 18 works as a negative electrode terminal.

The cylindrical battery 10 further comprises a resin-made gasket 27 arranged between the exterior can 15 and the sealing assembly 16. The gasket 27 is pinched and held by the exterior can 15 and the sealing assembly 16 and insulates the sealing assembly 16 from the exterior can 15. The gasket 27 has a role as a sealing material for holding gastightness inside the battery, and a role as an insulating material for insulating the exterior can 15 and the sealing assembly 16. The exterior can 15 has an annular grooved portion 21 at a portion thereof in the axial direction.

The grooved portion 21 can be formed, for example, by spinning processing of a part of the side wall inward in the radial direction to recess it inward in the radial direction. The exterior can 15 has a bottomed tubular portion 39 including the grooved portion 21, and an annular shoulder portion 38. The bottomed tubular portion 39 houses the electrode assembly 14 and the non-aqueous electrolyte, and the shoulder portion 38 is folded inward in the radial direction from the end on the opening side of the bottomed tubular portion 39 to extend inward. The shoulder portion 38 is formed when the upper end of the exterior can 15 is folded inward and crimped onto the peripheral edge of the sealing assembly 16. The sealing assembly 16 is crimp fixed to the exterior can 15 between the shoulder portion 38 and the grooved portion 21 via the gasket 27. As above, the inner space of the cylindrical battery 10 is hermetically sealed.

The sealing assembly 16 has a structure having the bottom plate 22, a lower vent member 23, an insulating member 24, an upper vent member 25, and the terminal plate 26 laminated in this order from the electrode assembly 14 side. Each of the members constituting the sealing assembly 16 has a disc shape or a ring shape, for example, and the members except the insulating member 24 are electrically connected to one another. The bottom plate 22 has at least one through hole 22a. Moreover, the lower vent member 23 and the upper vent member 25 are connected at their center portions, and the insulating member 24 is interposed between their peripheral edges.

When abnormal heat generation of the cylindrical battery 10 occurs and the internal pressure of the cylindrical battery 10 rises, the lower vent member 23 deforms so as to push up the upper vent member 25 to the terminal plate 26 side to rupture, and the current path between the lower vent member 23 and the upper vent member 25 is disconnected. When the internal pressure further rises, the upper vent member 25 ruptures to discharge gas from a through hole 26a of the terminal plate 26. The gas discharge can prevent the internal pressure of the cylindrical battery 10 from excessively rising followed by blowup of the cylindrical battery 10, which can enhance safety of the cylindrical battery 10.

### <Operation and Effects of Aforementioned Cylindrical Battery>

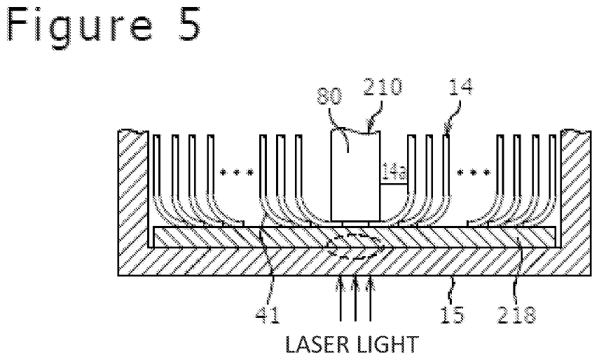

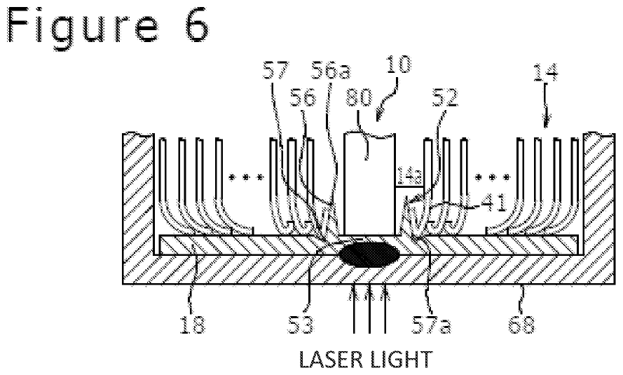

FIG. 5 is a schematic sectional view showing a lower side of a cylindrical battery 210 of a reference example, and FIG. 6 is a schematic sectional view, corresponding to FIG. 5, of the aforementioned cylindrical battery 10. Operation and effects of the cylindrical battery 10 are hereafter described mainly using the lower current collector plate 18. As shown in FIG. 5, in the cylindrical battery 210 of the reference example, there occasionally arises a case where, when the negative electrode core exposed portion 41 is pressed onto a lower current collector plate 218, the negative electrode core exposed portion 41 is inward inclined to the inner side in the radial direction to close an opening of the hollow 14a of the electrode assembly 14 partially. Therefore, in welding the lower current collector plate 218 and the exterior can 15, there occasionally arises a case where the lower current collector plate 218 cannot be brought into close contact with the exterior can 15 due to obstruction by the inward inclined negative electrode core exposed portion 41, which occasionally worsens insertion ability of a welding rod 80 into the hollow 14a and affects welding ability.

In contrast, according to the cylindrical battery 10 shown in FIG. 6, the lower current collector plate 18 has the integrated structure 52 having the protrusion portion 56 having the apex 56a to be housed in the hollow 14a of the electrode assembly 14, and the groove portion 57 integrally provided with the protrusion portion 56 on the outer side of the protrusion portion 56 in the radial direction to define the groove 57a. Accordingly, the negative electrode core exposed portion 41 which is being inward inclined to the hollow 14a side in the radial direction can be invited, led, and guided into the groove 57a of the groove portion 57 of the integrated structure 52, and furthermore, the protrusion portion 56 can prevent the negative electrode core exposed portion 41 from intruding into the hollow 14a side. As a result, the welding rod 80 can be smoothly inserted into the hollow 14a of the electrode assembly 14, and the flat plate portion 53 of the lower current collector plate 18 can be brought into close contact with the bottom plate portion 68 of the exterior can 15 by the welding rod 80. Therefore, the flat plate portion 53 can be securely joined to the bottom plate portion 68 by laser welding.

Moreover, since the integrated structure 52 is annular, the integrated structure 52 can also prevent places, of the negative electrode core exposed portion 41, that are not welded from intruding inward in the radial direction, and the lower current collector plate 18 and the exterior can 15 can be further securely welded.

Moreover, as shown in FIG. 4, since the place 57c that is positioned lowermost in the groove portion 57 of the lower current collector plate 18 is positioned, in the axial direction, between the upper surface (core joining portion) 51b of the ridge 51a of the lower current collector plate 18 and the plate joining portion 69 of the bottom plate portion 68, formation of the groove portion 57 can be prevented from affecting welding of the lower current collector plate 18 and the exterior can 15, and the lower current collector plate 18 can be securely welded to the exterior can 15.

Moreover, since the tip 56b of the protrusion portion 56 is positioned, in the axial direction, between the upper surface (core joining portion) 51b of the lower current collector plate 18 including the protrusion portion 56 and the negative electrode mixture layers 42 that are provided in the negative electrode core exposed portion 41 joined to the upper surface 51b, the protrusion portion 56 does not interfere with the negative electrode mixture layers 42, and the negative electrode mixture layers 42 can be prevented from being damaged due to interference with the protrusion portion 56.

Moreover, since the integrated structure 52 of the lower current collector plate 18 is positioned outward of the plate joining portion 69 of the bottom plate portion 68 in the radial direction, the negative electrode core exposed portion 41 can be prevented from intruding inward in the radial direction so as to overlap with the plate joining portion 69 in the axial direction, and the lower current collector plate 18 can be securely welded to the exterior can 15.

Moreover, since the surface, of the protrusion portion 56, that is outward in the radial direction has the inward displacing portion 43 that is displaced more inward in the radial direction as going to the tip 56b of the protrusion portion 56, there can be reduced force that the negative electrode core exposed portion 41 receives from that outward surface, and there can be reduced stress that arises on the negative electrode core exposed portion 41 based on this force. Accordingly, since there can also be reduced stress that arises on the negative electrode mixture layers 42 caused by that stress, the cylindrical battery 10 that has a long service life and is excellent is readily produced.

Furthermore, as shown in FIG. 1, since the cylindrical battery 10 comprises the upper current collector plate 19 having the through hole 19a inward of the integrated structure 52 in the radial direction, the through hole 19a can be restrained from being closed by the positive electrode core exposed portion 31, and the electrolyte can be smoothly injected using through hole 19a into the exterior can 15.

### <Tests for Examining Operation and Effects>

### [Tests for Examining Hole Diameters]

The inventors conducted tests for examining lower opening diameters of hollows of electrode assemblies. Specifically, there were prepared a lower current collector plate (negative electrode current collector plate) that does not have an integrated structure constituted of a groove portion and a protrusion portion, and the aforementioned lower current collector plate (negative electrode current collector plate) which has the integrated structure, there was pressed a negative electrode core exposed portion constituting the lower end of an electrode assembly onto each lower current collector plate, and after that, the electrode assembly was separated from the lower current collector plate to measure the smallest diameter of the lower opening of the hollow of the electrode assembly. Then, there was obtained its ratio relative to the diameter of the lower opening of the hollow before the negative electrode core exposed portion was pressed onto each lower current collector plate.

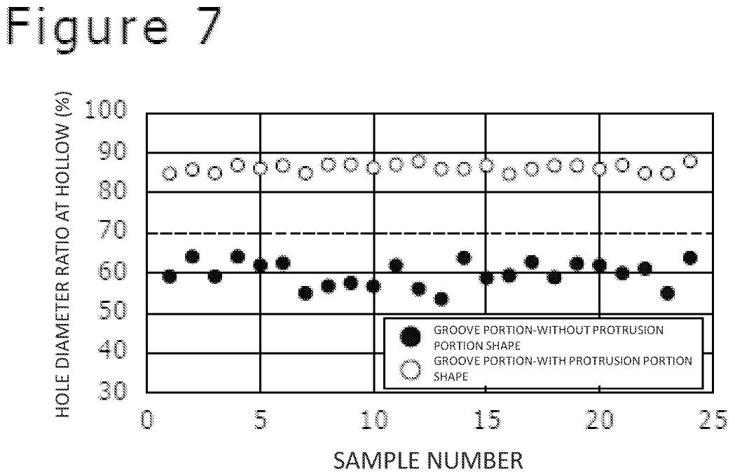

FIG. 7 is a graph showing the results. As shown in FIG. 7, while when the lower current collector plates not having the integrated structure were used, the hole diameter of each electrode assembly decreased down to about 60%, when the lower current collector plates not having the integrated structure were used, the hole diameter of each electrode assembly was able to decrease just to about 90%, larger than 70% allowing excellent welding. Accordingly, it was able to be confirmed that the integrated structure of the lower current collector plate of the present disclosure was able to restrain the negative electrode core exposed portion from being inward inclined and excellent welding was able to be attained.

### <Modifications>

The present disclosure is not limited to the aforementioned embodiment or its modifications but various improvements and alterations may occur without departing from the matters disclosed in the claims and their equivalents. For example, for the aforementioned embodiment, there has been described a case where the cylindrical battery 10 comprises the upper current collector plate 19 arranged on the upper side of the electrode assembly 14 and the lower current collector plate 18 arranged on the lower side of the electrode assembly 14. Nonetheless, the cylindrical battery may have the upper current collector plate only or may have the lower current collector plate only. Moreover, in such a case, the core exposed portion on the side on which a current collector plate is not provided may be electrically connected, using one or more leads that are joined thereto, to the sealing assembly or the exterior can.

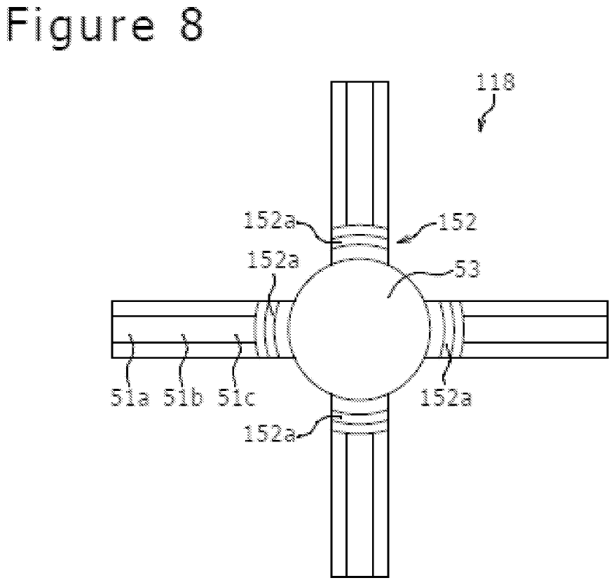

Moreover, as shown in FIG. 8, that is, a plan view, corresponding to FIG. 3, of a lower current collector plate 118 of a modification on an integrated structure 152 formation side, the integrated structure 152 is not necessarily annular but may be constituted of a plurality of portions 152a arranged at intervals in the circumferential direction. Notably, even in this case, as shown in FIG. 8, the upper surfaces 51b of the ridges 51a constituting the core joining portion of the lower current collector plate 118 include the facing portions 51c that face the integrated structure 152 in the radial direction.

### REFERENCE SIGNS LIST

10 cylindrical battery, 11 positive electrode, 12 negative electrode, 13 separator, 14 electrode assembly, 14a hollow, 15 exterior can, 16 sealing assembly, 17 insulating plate, 17a through hole, 18, 118 lower current collector plate (current collector plate), 19 upper current collector plate (current collector plate), 19a through hole, 21 grooved portion, 22 bottom plate, 22a through hole, 23 lower vent member, 24 insulating member, 25 upper vent member, 26 terminal plate, 26a through hole, 27 gasket, 29 connection lead, 30 positive electrode core, 31 positive electrode core exposed portion, 32 positive electrode mixture layer, 36 flat plate portion, 38 shoulder portion, 39 bottomed tubular portion, 40 negative electrode core, 41 negative electrode core exposed portion, 42 negative electrode mixture layer, 43 inward displacing portion, 51, 61 radial directional extending portion, 51a, 61a ridge, 51b upper surface, 51c, 61d facing portion, 52, 62, 152 integrated structure, 53, 63 flat plate portion, 53a bottom surface, 56, 66 protrusion portion, 56a, 66a apex, 56b tip, 57, 67 groove portion, 57a, 67a groove, 57b groove bottom, 57c place, 61b groove, 61c lower surface, 68 bottom plate portion, 68a inner surface, 69 plate joining portion, 80 welding rod, 152a portions constituting an integrated structure

1. A cylindrical battery, comprising:
a wound electrode assembly having a positive electrode and a negative electrode wound via a separator and having a hollow extending in an axial direction; and
a current collector plate that has a protrusion portion having an apex housed in the hollow and a groove portion integrally provided with the protrusion portion on an outer side of the protrusion portion in a radial direction to define a groove and that is provided outward of the wound electrode assembly in the axial direction, wherein
a core exposed portion in which a mixture layer is not provided on a core of at least one of the positive electrode and the negative electrode is joined to a core joining portion of the current collector plate, and
the core joining portion includes a facing portion that faces, in the radial direction, an integrated structure constituted of the protrusion portion and the groove portion.

2. The cylindrical battery according to claim 1, wherein the integrated structure is annular.

3. The cylindrical battery according to claim 1, comprising
a bottomed tubular exterior can, wherein
the current collector plate includes a lower current collector plate joined to a plate joining portion of a bottom plate portion of the exterior can, and
a place that is positioned on the most bottom plate portion side in the axial direction in the groove portion of the lower current collector plate is positioned, in the axial direction, between the core joining portion of the lower current collector plate and the plate joining portion.

4. The cylindrical battery according to claim 1, wherein a tip of the protrusion portion is positioned, in the axial direction, between the core joining portion of the current collector plate that includes the protrusion portion and the mixture layer that is provided in the core exposed portion joined to the core joining portion.

5. The cylindrical battery according to claim 1, comprising
a bottomed tubular exterior can, wherein
the current collector plate includes a lower current collector plate joined to a plate joining portion of a bottom plate portion of the exterior can, and
the integrated structure of the lower current collector plate is positioned outward of the plate joining portion in the radial direction.

6. The cylindrical battery according to claim 1, comprising
a sealing assembly, wherein
the current collector plate includes an upper current collector plate connected to the sealing assembly via a connection lead, and
the upper current collector plate has a through hole inward of the integrated structure in the radial direction.

7. The cylindrical battery according to claim 1, wherein a surface, of the protrusion portion, that is outward in the radial direction has an inward displacing portion that is displaced more inward in the radial direction as going to a tip of the protrusion portion.
